(19) United States
(12) Patent Application Publication
(10) Pub. No.: US 2026/0168297 A1
(43) Pub. Date: Jun. 18, 2026

(54) Door flip guard security system and device

(71) Applicants: Thedoshia L. Shealey, Warner Robins, GA (US); Louis Shealey, JR., Warner Robins, GA (US)

(72) Inventors: Thedoshia L. Shealey, Warner Robins, GA (US); Louis Shealey, JR., Warner Robins, GA (US)

(21) Appl. No.: 19/389,496

(22) Filed: Nov. 14, 2025

Related U.S. Application Data
(60) Provisional application No. 63/735,812, filed on Dec. 18, 2024.

(51) Int. Cl. E05C 17/54

(52) U.S. Cl. CPC E05C 17/54

(57) ABSTRACT

A door flip guard security system includes a door flip guard, including a flip guard base mount with a wall base member and a protruding base member, and a flip guard plate; and a door flip guard security device, including a security body with downward projecting inner and outer legs, and a top bridge; a locking pin assembly with a locking pin and locking clamp; and a security lanyard for securing the locking pin assembly to the security body of the door flip guard security device; such that the door flip guard security device is mountable on the door flip guard of a hotel guestroom door when the flip guard plate is flipped outward in the open position, such that the downward projecting inner leg blocks a flip guard gap between the hotel guestroom door and the flip guard plate, to prevent opening of the hotel guestroom door.

### CROSS-REFERENCE TO RELATED APPLICATIONS

This U.S. Non-Provisional Application claims the benefit of U.S. Provisional Application No. 63/735,812, filed Dec. 18, 2024; which is hereby incorporated herein by reference in its entirety.

### FIELD OF THE INVENTION

The present invention relates generally to the field of door safety guards, and more particularly to methods and systems for improving the function of a hotel guestroom door latch style flip guard.

### BACKGROUND OF THE INVENTION

Safety for hotel guests remains a topic of high concern for both hotels and their guests. Hotel systems often employ mechanical door lockers to protect their guests from unauthorized entry. A popular design for this is the hotel guestroom door flip guard, also known as a door security guard or privacy door latch, a simple mechanism that provides an extra layer of security for hotel rooms equipped with a guestroom door latch style flip guard. It allows guests to partially open the door for ventilation or communication while maintaining privacy and preventing unauthorized entry. The guard typically consists of a metal plate that pivots on a hinge, secured to the door frame. When the metal plate is flipped out, it blocks the door from being opened even if the main lock is compromised.

However, the design of hotel guestroom door flip guards is not optimal for privacy and security as partial opening of the hotel guestroom door may allow an intruder to peek in and also enable mechanical leverage, such that the intruder can insert a lever rod to force the door open.

As such, considering the foregoing, it may be appreciated that there continues to be a need for novel and improved devices and methods for improving the function of a hotel guestroom door flip guard.

### SUMMARY OF THE INVENTION

The foregoing needs are met, to a great extent, by the present invention, wherein in aspects of this invention, enhancements are provided to the existing model of hotel guestroom door flip guards.

In an aspect, a door flip guard security system can include:
a) a door flip guard, which can include:
   i. a flip guard base mount, which is mounted on a wall next to a hotel guestroom door; and
   ii. a flip guard plate, which is pivotably mounted to the flip guard base mount, such that the flip guard plate can be pivotable to an open flip guard position with the flip guard plate flipped outward, such that the flip guard plate stops full opening of the hotel guestroom door, but still allows partial opening of the hotel guestroom door;
b) a door flip guard security device, which can include:
   i. a security body, which can be block-shaped and substantially U-shaped, wherein the security body comprises:
      1) a downward projecting inner leg, wherein a lower end of the downward projecting inner leg can further include:
         an inner horizontal aperture, which penetrates horizontally through the lower end of the downward projecting inner leg;
      2) a downward projecting outer leg, wherein a lower end of the downward projecting outer leg can further include:
         an outer horizontal aperture, which penetrates horizontally through the lower end of the downward projecting outer leg; and
      3) a top bridge, which is horizontally connected between top ends of the downward projecting inner leg and the downward projecting outer leg;
wherein the door flip guard security device can be mountable on the door flip guard when the flip guard plate is in the open flip guard position with the flip guard plate flipped outward, such that the downward projecting inner leg projects downward through a flip guard gap between the hotel guestroom door and the flip guard plate, and such that the downward projecting outer leg projects downward on an outer side of the flip guard base mount;
such that the downward projecting inner leg blocks the flip guard gap, whereby an opening movement capability of the hotel guestroom door can be substantially reduced.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways, such as enhancements and improvements, as well as components to include technological enhancements. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1A is a front perspective view of a door flip guard security system installed on a door, according to an embodiment of the invention.

FIG. 1B is a top perspective view of a door flip guard security system installed on a door, according to an embodiment of the invention.

FIG. 1C is a front perspective view of a door flip guard security system, according to an embodiment of the invention.

FIG. 2A is a top front perspective view of a door flip guard security device, according to an embodiment of the invention.

FIG. 2B is a first bottom rear perspective view of a door flip guard security device, according to an embodiment of the invention.

FIG. 2C is a second bottom rear perspective view of a door flip guard security device, according to an embodiment of the invention.

FIG. 3A is a top front exploded perspective view of a door flip guard security device, according to an embodiment of the invention.

FIG. 3B is a bottom rear exploded perspective view of a door flip guard security device, according to an embodiment of the invention.

FIG. 4 is a flowchart illustrating steps that may be followed, in accordance with one embodiment of a method or process of using a door flip guard security device.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

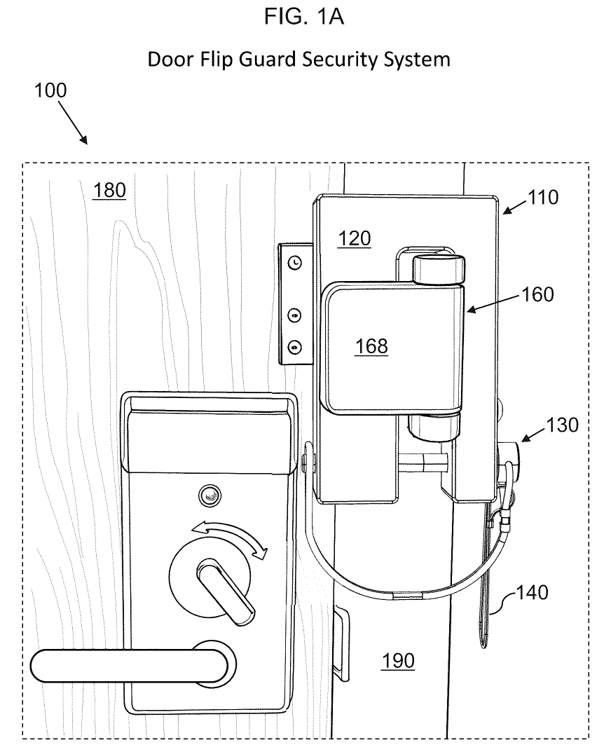

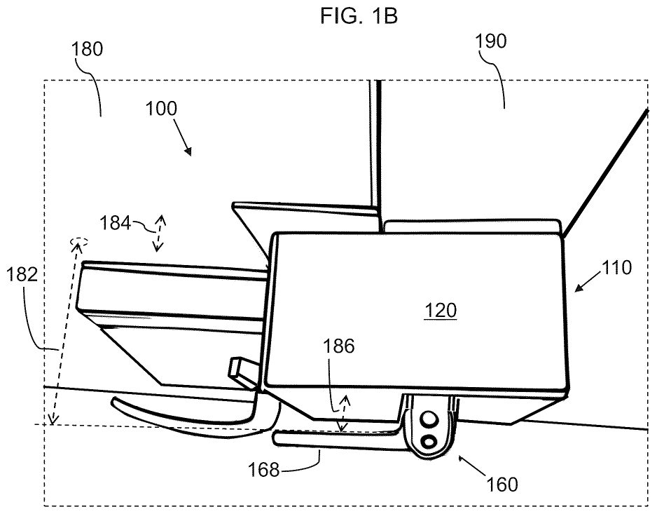

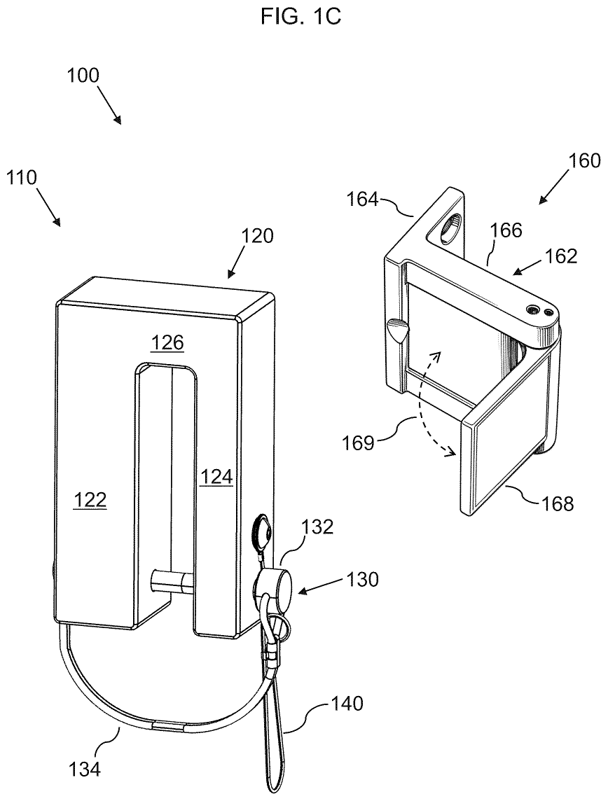

In the following, we describe the structure of an embodiment of a flip guard security system 100 with reference to FIG. 1, in such manner that like reference numerals refer to like components throughout; a convention that we shall employ for the remainder of this specification.

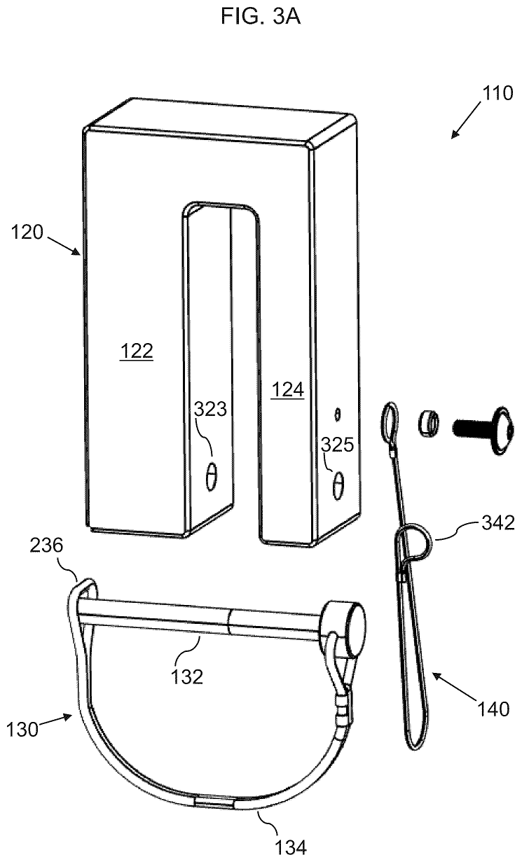

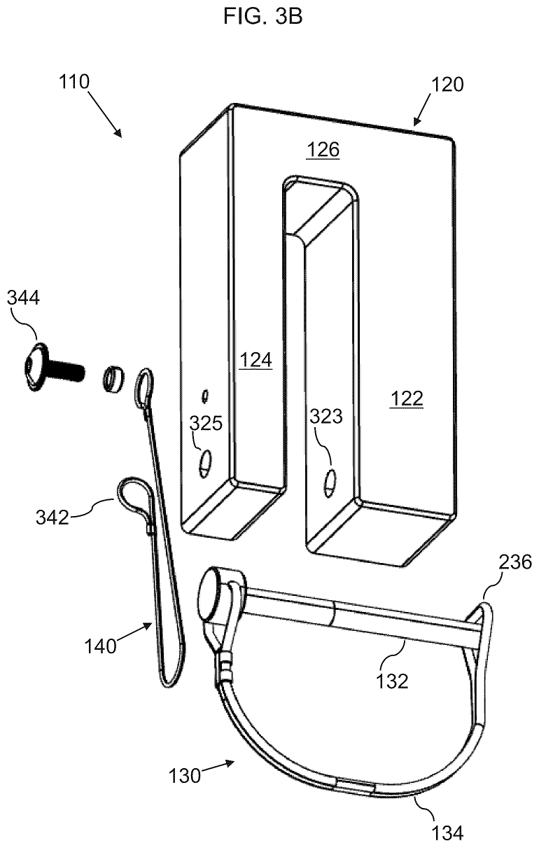

In an embodiment, as shown in FIGS. 1A-1C and 3A-3B, a door flip guard security system 100 can include:
a) a door flip guard 160, which can be installed adjacent to a hotel guestroom door, wherein the door flip guard 160 can include:
   i. a flip guard base mount 162, which is mounted on a wall 190 next to a hotel guestroom door 180; and
   ii. a flip guard plate 168, which is pivotably 169 mounted to the flip guard base mount 162, such that the flip guard plate 168 can be pivotable 169 to an open flip guard position (i.e., “flipped out”, as shown in FIGS. 1A-1C) with the flip guard plate 168 flipped outward, such that the flip guard plate 168 stops full opening of the hotel guestroom door 180, but still allows partial opening of the hotel guestroom door 180, such as for example with a 1-2 inch flip guard gap 182 between the hotel guestroom door 180 and the flip guard plate 168;
b) a door flip guard security device 110, which can include:
   i. a security body 120, which can be block-shaped and substantially U-shaped, wherein the security body 120 comprises:
      1) a downward projecting inner leg 122, wherein a lower end of the downward projecting inner leg 122 can further include:
         an inner horizontal aperture 323, which penetrates horizontally through the lower end of the downward projecting inner leg 122;
      2) a downward projecting outer leg 124, wherein a lower end of the downward projecting outer leg 124 can further include:
         an outer horizontal aperture 325, which penetrates horizontally through the lower end of the downward projecting outer leg 124; and
      3) a top bridge 126, which is horizontally connected between top ends of the downward projecting inner leg 122 and the downward projecting outer leg 124;
         such that the top bridge 126 spans above the protruding base member 166 with the downward projecting inner leg 122 on the door side and the downward projecting outer leg 124 on the wall side;
wherein the door flip guard security device 110 can be mountable on the door flip guard 160 when the flip guard plate 168 is in the open flip guard position with the flip guard plate 168 flipped outward, such that the downward projecting inner leg 122 projects downward through a flip guard gap 182 between the hotel guestroom door 180 and the flip guard plate 168, and such that the downward projecting outer leg 124 projects downward on an outer side of the flip guard base mount 162;
such that the downward projecting inner leg 122 blocks the flip guard gap 182, whereby an opening movement capability 184 of the hotel guestroom door 180 can be substantially reduced, such as for example a reduction from a 1-2 inch opening movement to no more than a ¼ inch opening movement, wherein the opening movement capability 184 corresponds to a mounting gap 186 between the security body 120 of the door flip guard security device 110 and the flip guard plate 168 of the door flip guard 160.

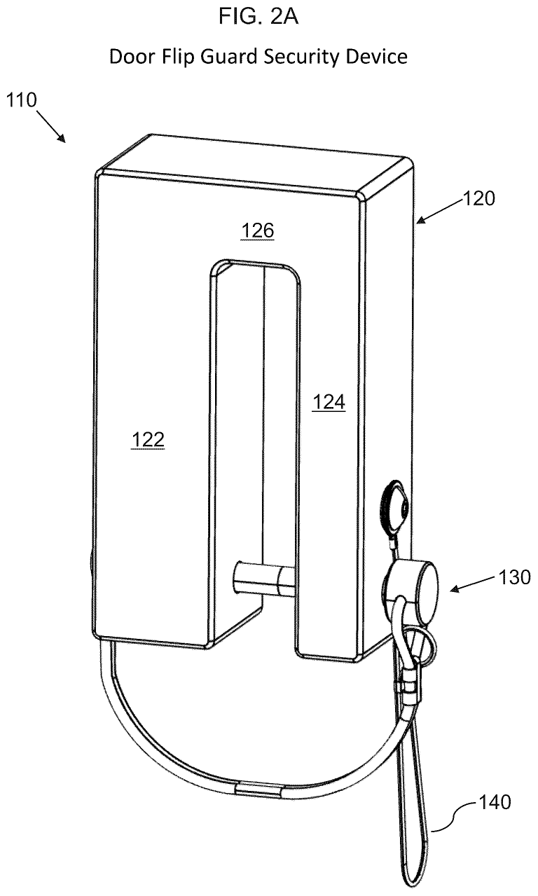

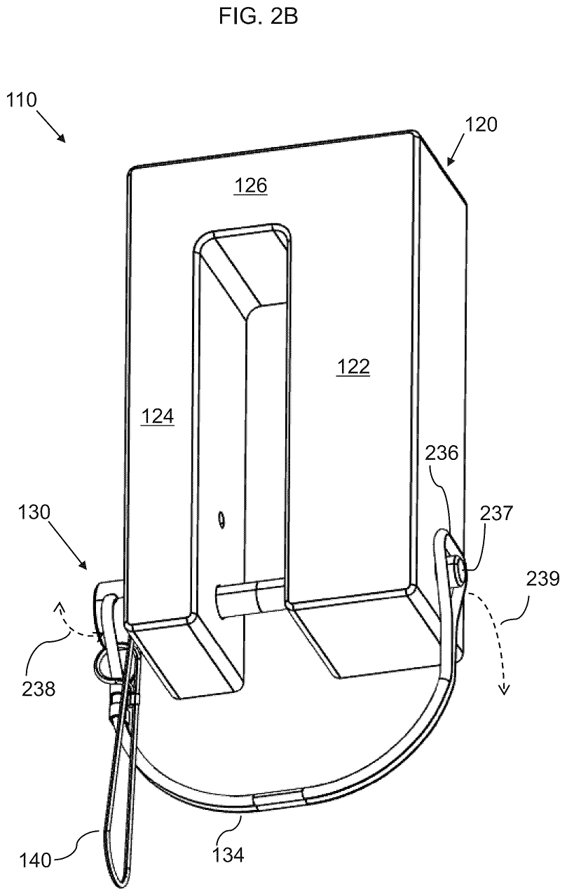

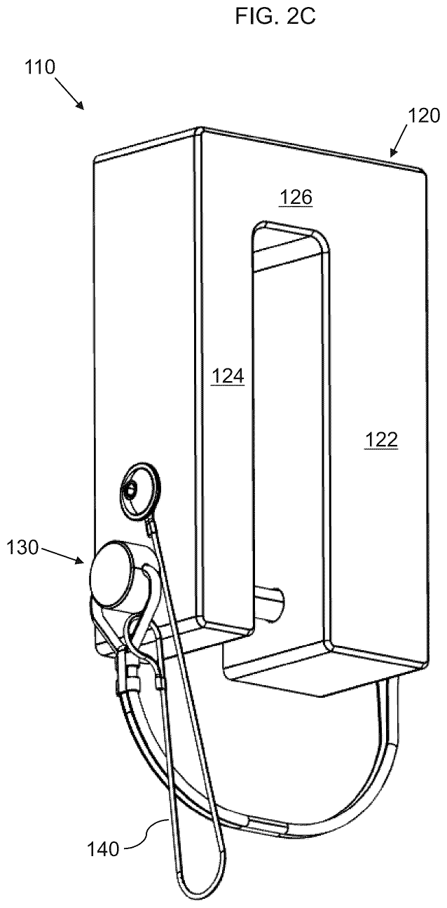

In a related embodiment, as shown in FIGS. 2A-2B and 3A-3B, the door flip guard security device 110 can further include:
a) a Locking pin assembly 130, which can include:
   i. a locking pin 132, which is configured to be inserted through the inner horizontal aperture 323 and the outer horizontal aperture 325, such that the security body 120 is secured in position when the door flip guard security device 110 is mounted on the door flip guard 160 with the locking pin 132 inserted through the inner horizontal aperture 323 and the outer horizontal aperture 325; and
   ii. a locking clamp 134, which is configured to secure the locking pin 132 in position to prevent removal of the locking pin 132 (and thereby enable removal of the security body 120 of the door flip guard security device 110);
   wherein an inner end of the locking clamp 134 can be pivotably 238 connected to an inner end of the locking pin 132, such that an outer end of the locking clamp 134 is configured to be detachably connected to an outer end 237 of the locking pin 132;
   such that the outer end 236 of the locking clamp 134 is detachable, whereby the locking clamp 134 can be pivoted 238 and opened 239 to an open position for removal of the locking pin 132 from the security body 120 of the door flip guard security device 110;
   such that the locking pin assembly 130 and the locking pin 132 can prevent an intruder from using an object to push the security body 120 off the door flip guard 160; and
b) a security lanyard 140, which can be configured to secure a connection between the security body 120 and the locking pin assembly 130 to prevent loss of the locking pin assembly 130 when it is not mounted on the security body 120;
   wherein an inner end of the security lanyard 140 can be attached to the security body 120 for example using a screw 344, such as a button head screw, and wherein an outer end of the security lanyard 140 can be connected to the locking pin assembly 130, such that the outer end of the security lanyard 140 can be configured as a loop 342, which is attached to the locking clamp 134.

In a further related embodiment, the outer end 236 of the locking clamp 134 can be hook-shaped or loop-shaped to enable a detachable connection with the outer end 237 of the locking pin 132, such that the outer end 236 of the locking clamp 134 detachably clips on (or snaps on) to the outer end 237 of the locking pin 132.

In another related embodiment, as shown in FIG. 1C, the flip guard base mount 162 can further include:
a) a wall base member 164, which is configured to attach to the wall 190; and
b) a protruding base member 166, which is attached to the wall base member 164, such that the protruding base member 166 is configured to protrude perpendicularly from the wall 190 when the flip guard base mount 162 is attached to the wall;
   wherein the flip guard plate 168 is pivotably mounted to an outer end of the protruding base member 166;
   such that the security body 120 can be configured to rest on the protruding base member 166 when the door flip guard security device 110 is mounted on the door flip guard 160, such that the downward projecting inner leg 122 projects downward on an inner side of the protruding base member 166, and such that the downward projecting outer leg 124 projects downward on an outer side of the protruding base member 166.

In related embodiments, the security body 120 can be made of wood; a metal or metal alloy, including aluminum, which can be hardened aluminum; a composite material; or combinations thereof.

In related embodiments, the locking pin 132 and locking clamp 134 can each be made from a metal or metal alloy, such as stainless steel, brass, or a copper-nickel-zinc alloy.

In another related embodiment, each of the downward projecting inner leg 122, the downward projecting outer leg 124, and the top bridge 126 can be substantially rectangular (i.e. rectangular with rounded or beveled edges).

In yet another related embodiment, the security lanyard 140 can be configured with a length in a range of 5-8 inches.

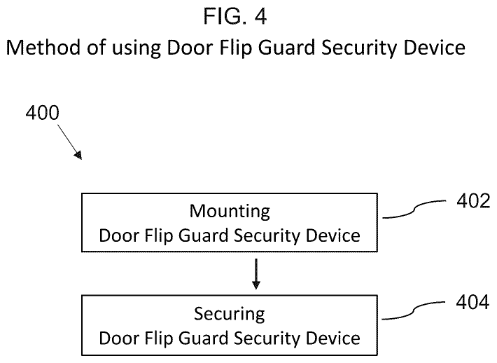

In an embodiment, as illustrated in FIG. 4, a method 400 using a door flip guard security device 110, can include:
a) Mounting 402 the door flip guard security device 110 on a door flip guard 160, which is installed adjacent to a door 180; and
b) Securing 404 the door flip guard security device 110 with a locking pin 132.

Here has thus been described a multitude of embodiments of the flip guard security system 100 and the door flip guard security device 110, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent and should be considered fully included in this specification and the claims appended hereto. Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. A door flip guard security system, comprising:
a) a door flip guard, which comprises
a flip guard base mount, which is mounted on a wall next to a door; and
a flip guard plate, which is pivotably mounted to the flip guard base mount, such that the flip guard plate is configured to be pivotable to an open flip guard position wherein the flip guard plate is flipped outward, such that the flip guard plate stops full opening of the door, but still allows partial opening of the door; and
b) a door flip guard security device, comprising:
a security body, which comprises:
a downward projecting inner leg;
a downward projecting outer leg; and
a top bridge, which is connected between top ends of the downward projecting inner leg and the downward projecting outer leg;
wherein the door flip guard security device is configured to be mountable on the door flip guard when the flip guard plate is in the open flip guard position, such that the downward projecting inner leg projects downward through a flip guard gap between the door and the flip guard plate, and such that the downward projecting outer leg projects downward on an outer side of the flip guard base mount;
such that the downward projecting inner leg blocks the flip guard gap, whereby an opening movement capability of the door is reduced.

2. The door flip guard security system of claim 1,
wherein a lower end of the downward projecting inner leg further comprises:
an inner horizontal aperture, which penetrates horizontally through the lower end of the downward projecting inner leg;
wherein a lower end of the downward projecting outer leg further comprises:
an outer horizontal aperture, which penetrates horizontally through the lower end of the downward projecting outer leg; and
wherein the door flip guard security device further comprises:
a locking pin assembly, comprising:
a locking pin, which is configured to be inserted through the inner horizontal aperture and the outer horizontal aperture;
such that the security body is secured in position when the door flip guard security device is mounted on the door flip guard with the locking pin inserted through the inner horizontal aperture and the outer horizontal aperture.

3. The door flip guard security system of claim 2, wherein the locking pin assembly further comprises:
a locking clamp, which is configured to secure the locking pin in position to prevent removal of the locking pin;
wherein an inner end of the locking clamp is pivotably connected to an inner end of the locking pin, and wherein an outer end of the locking clamp is configured to be detachably connectable to an outer end of the locking pin.

4. The door flip guard security system of claim 3, wherein the door flip guard security device further comprises:
a security lanyard, which is connected between the security body and the locking pin assembly to prevent loss of the locking pin assembly when it is not mounted on the security body.

5. The door flip guard security system of claim 4, wherein an inner end of the security lanyard is attached to the security body and wherein an outer end of the security lanyard is connected to the locking pin assembly.

6. The door flip guard security system of claim 5, wherein the outer end of the security lanyard is configured as a loop, which is attached to the locking clamp of the locking pin assembly.

7. The door flip guard security system of claim 1, wherein the security body is made of hardened aluminum.

8. The door flip guard security system of claim 1, wherein the downward projecting inner leg is rectangular.

9. The door flip guard security system of claim 1, wherein each of the downward projecting inner leg, the downward projecting outer leg, and the top bridge is rectangular.

10. The door flip guard security system of claim 1, wherein the flip guard base mount further comprises:
a protruding base member, which is configured to protrude from the wall when the flip guard base mount is attached to the wall;
such that the flip guard plate is pivotably mounted to an outer end of the protruding base member;
such that the security body is configured to rest on the protruding base member when the door flip guard security device is mounted on the door flip guard, such that the top bridge spans above the protruding base member, such that the downward projecting inner leg projects downward on an inner side of the protruding base member, and such that the downward projecting outer leg projects downward on an outer side of the protruding base member.

11. The door flip guard security system of claim 10, wherein the flip guard base mount further comprises:
a wall base member, which is configured to attach to the wall, such that the protruding base member is attached to the wall base member.

12. A door flip guard security device, comprising:
a security body, which comprises:
a downward projecting inner leg;
a downward projecting outer leg; and
a top bridge, which is connected between top ends of the downward projecting inner leg and the downward projecting outer leg;
wherein the door flip guard security device is configured to be mountable on a door flip guard, which is installed adjacent to a door, when a flip guard plate of the door flip guard is in an open flip guard position wherein the flip guard plate is flipped outward, such that the downward projecting inner leg projects downward through a flip guard gap between the door and the flip guard plate, and such that the downward projecting outer leg projects downward on an outer side of a flip guard base mount of the door flip guard;
such that the downward projecting inner leg blocks the flip guard gap, whereby an opening movement capability of the door is reduced.

13. The door flip guard security device of claim 12,
wherein a lower end of the downward projecting inner leg further comprises:
an inner horizontal aperture, which penetrates horizontally through the lower end of the downward projecting inner leg;
wherein a lower end of the downward projecting outer leg further comprises:
an outer horizontal aperture, which penetrates horizontally through the lower end of the downward projecting outer leg; and
wherein the door flip guard security device further comprises:
a locking pin assembly, comprising:
a locking pin, which is configured to be inserted through the inner horizontal aperture and the outer horizontal aperture;
such that the security body is secured in position when the door flip guard security device is mounted on the door flip guard with the locking pin inserted through the inner horizontal aperture and the outer horizontal aperture.

14. The door flip guard security device of claim 13, wherein the locking pin assembly further comprises:
a locking clamp, which is configured to secure the locking pin in position to prevent removal of the locking pin;
wherein an inner end of the locking clamp is pivotably connected to an inner end of the locking pin, and wherein an outer end of the locking clamp is configured to be detachably connectable to an outer end of the locking pin.

15. The door flip guard security device of claim 14, wherein the door flip guard security device further comprises:
a security lanyard, which is connected between the security body and the locking pin assembly to prevent loss of the locking pin assembly when it is not mounted on the security body.

16. The door flip guard security device of claim 15, wherein an inner end of the security lanyard is attached to the security body and wherein an outer end of the security lanyard is connected to the locking pin assembly.

17. The door flip guard security device of claim 16, wherein the outer end of the security lanyard is configured as a loop, which is attached to the locking clamp of the locking pin assembly.

18. A method of using a door flip guard security device, comprising:
mounting the door flip guard security device on a door flip guard, which is installed adjacent to a door;
wherein the door flip guard security device, comprises:
a security body, which comprises:
a downward projecting inner leg;
a downward projecting outer leg; and
a top bridge, which is connected between top ends of the downward projecting inner leg and the downward projecting outer leg;
wherein the door flip guard security device is configured to be mountable on a door flip guard, which is installed adjacent to a door, when a flip guard plate of the door flip guard is in an open flip guard position wherein the flip guard plate is flipped outward, such that the downward projecting inner leg projects downward through a flip guard gap between the door and the flip guard plate, and such that the downward projecting outer leg projects downward on an outer side of a flip guard base mount of the door flip guard;
such that the downward projecting inner leg blocks the flip guard gap, whereby an opening movement capability of the door is reduced.

19. The method of claim 18, further comprising:
securing the door flip guard security device with a locking pin;
wherein a lower end of the downward projecting inner leg further comprises:
an inner horizontal aperture, which penetrates horizontally through the lower end of the downward projecting inner leg;
wherein a lower end of the downward projecting outer leg further comprises:
an outer horizontal aperture, which penetrates horizontally through the lower end of the downward projecting outer leg; and
wherein the door flip guard security device further comprises:
a locking pin assembly, comprising:
the locking pin, which is configured to be inserted through the inner horizontal aperture and the outer horizontal aperture;
such that the security body is secured in position when the door flip guard security device is mounted on the door flip guard with the locking pin inserted through the inner horizontal aperture and the outer horizontal aperture.

20. The method of claim 19, wherein the locking pin assembly further comprises:
a locking clamp, which is configured to secure the locking pin in position to prevent removal of the locking pin;
wherein an inner end of the locking clamp is pivotably connected to an inner end of the locking pin, and wherein an outer end of the locking clamp is configured to be detachably connectable to an outer end of the locking pin.
